(19) United States
(12) Patent Application Publication
(10) Pub. No.: US 2026/0126641 A1
(43) Pub. Date: May 7, 2026

(54) IMAGING SYSTEMS WITH FIBER OPTIC LIGHT SOURCES

(71) Applicant: Intuitive Surgical Operations, Inc., Sunnyvale, CA (US)

(72) Inventor: S. Christopher ANDERSON, San Francisco, CA (US)

(73) Assignee: Intuitive Surgical Operations, Inc., Sunnyvale, CA (US)

(21) Appl. No.: 18/714,238

(22) PCT Filed: Dec. 6, 2022
(86) PCT No.: PCT/US2022/051991

§ 371 Date: May 29, 2024

Related U.S. Application Data
(60) Provisional application No. 63/287,446, filed on Dec. 8, 2021.

(51) Int. Cl. G02B 23/24; G02B 6/04; H04N 23/56

(52) U.S. Cl. CPC G02B 23/2469; G02B 6/04; H04N 23/56

(57) ABSTRACT

Imaging instruments and related methods are disclosed. In some examples, an elongated body may include a channel extending through at least a portion of the elongated body and an articulable portion extending along at least a portion of a length of the elongated body. A fiber optic bundle may be disposed in and extend through the channel of the elongated body. A sheath may be disposed in the channel along at least a portion of the elongated body including the articulable portion. At least a portion of the fiber optic bundle may be disposed in the sheath. The axial compressive stiffness of the sheath may be greater than an axial compressive stiffness of the fiber optic bundle to at least partially shield the fiber optic bundle from axial forces and limit axial movement of the fiber optic bundle during articulation of the elongated body.

### CROSS-REFERENCE TO RELATED APPLICATIONS

This patent application claims priority to and the filing date benefit of U.S. Provisional Patent Application No. 63/287,446, filed Dec. 8, 2021, entitled “IMAGING SYSTEMS WITH FIBER OPTIC LIGHT SOURCES,” which is incorporated by reference herein in its entirety.

### FIELD

Disclosed examples are related to imaging systems with fiber optic light sources.

### BACKGROUND

Minimally invasive medical techniques are aimed at reducing the amount of extraneous tissue that is damaged during diagnostic or surgical procedures, thereby reducing patient recovery time, discomfort, and deleterious side effects. The average length of a hospital stay for a standard surgery may also be shortened significantly using minimally invasive surgical techniques. Thus, an increased adoption of minimally invasive techniques could save millions of hospital days, and millions of dollars annually in hospital residency costs alone. Patient recovery times, patient discomfort, surgical side effects, and time away from work may also be reduced with minimally invasive surgery.

A common form of minimally invasive surgery is endoscopy. Endoscopic instruments generally include an endoscope (for viewing the surgical field) and working tools. In endoscopic procedures, the working tools may be similar to those used in conventional (e.g., open) procedures, except that the working end or end effector of each tool may be separated from its handle by an extension tube. In some instances, an endoscope, or other medical instrument, may include an imaging instrument to permit the medical practitioner to view the procedure within the surgical site.

### SUMMARY

In one example, an imaging instrument includes: an elongated body including a channel extending through the elongated body, where the elongated body includes an articulable portion extending along at least a portion of a length of the elongated body; a fiber optic bundle configured to be operatively coupled to a light source, where the fiber optic bundle is disposed in and extends through the channel of the elongated body; and a sheath disposed in the channel, where at least a portion of the fiber optic bundle is disposed in the sheath, and an axial compressive stiffness of the sheath is greater than an axial compressive stiffness of the fiber optic bundle.

In another example, a method of illuminating a surface includes: articulating an articulable portion of an elongated body including a channel extending through the elongated body; illuminating the surface with light emitted from a fiber optic bundle disposed in and extending through the channel of the elongated body; and limiting axial movement of at least a portion of the fiber optic bundle disposed in the articulable portion of the elongated body with a sheath disposed in the channel.

In yet another example, an articulating instrument includes: an elongated body including a channel extending through the elongated body, where the elongated body includes an articulable portion extending along at least a portion of a length of the elongated body; a fiber optic bundle configured to be operatively coupled a light source, where the fiber optic bundle is disposed in and extends through the channel of the elongated body; and a solid coil spring disposed in at least a portion of the channel, wherein at least a portion of the fiber optic bundle is disposed in the solid coil spring.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting examples when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic of one example of an imaging system;

FIG. 2A is a schematic side view of one example of a distal articulable portion of an imaging instrument;

FIG. 2B is a cross-sectional view of the imaging instrument of FIG. 2A taken along line 2B;

FIG. 3A is a schematic top view of one example of a distal articulable portion of an imaging instrument;

FIG. 3B is a cross-sectional view of the imaging instrument of FIG. 3A taken along line 3B;

FIG. 4 is a schematic perspective partial cross-sectional of a distal articulable portion of an imaging instrument;

FIG. 5 is a schematic view of parallel fiber optic bundles extending distally from a primary fiber optic bundle both with and without an elastic jacket bundling the separate fiber optic bundles together;

FIG. 6 is a schematic cross-sectional view of a fiber optic bundle passing through a solid spring;

FIG. 7 is a schematic cross-sectional view of a sheath including serially arranged rings disposed with an outer flexible tube disposed around the stack of rings;

FIG. 8 is a schematic cross-sectional view of a sheath including serially arranged overmolded rings;

FIG. 9 is a schematic perspective cross sectional view of a fiber optic bundle core disposed within and extending through a hollow core of a length of wire cable;

FIG. 10 is a schematic cross-sectional view of a sheath including an overmolded solid spring;

FIG. 11 is a schematic cross-sectional view of a sheath including an overmolded set of spaced apart serially arranged rings;

FIG. 12A depicts the movement of unsupported fiber optic bundles within an articulable portion of an imaging instrument in both articulated and unarticulated configurations; and

FIG. 12B depicts the light leakage from an articulable imaging instrument including breaks in optical fibers located within unsupported fiber optic bundles.

### DETAILED DESCRIPTION

In certain applications, such as endoscopic imaging, an imaging instrument may include one or more portions that may undergo articulation during use. During articulation of the imaging instrument, the fiber optic bundles included in the instrument for either illumination and/or imaging purposes may be subject to various forces and displacements. This application of force to the fiber optic bundles may lead to undesired structural responses in instruments including an oversized interior channel with a smaller fiber optic bundle disposed therein, and fiber optic bundles disposed within a channel but initially offset from a neutral bending axis of the articulable instrument. In these constructions, and others, the one or more fiber optic bundles may be subjected to forces that change both a longitudinal and lateral position of one or more sections of the fiber optic bundle as the instrument transitions between an articulated and unarticulated configuration. This may result in undesirable buckling and the generation of excessive shear stresses in a fiber optic bundle. Additionally, even fiber optic bundles that are disposed along a neutral bending axis of the articulable instrument may include portions of the fiber optic bundle that are subjected to tension and compression on opposite sides of the neutral bending axis as the instrument transitions between articulated and unarticulated configurations.

Applied stresses, buckling, and other effects fiber optic bundles may be subjected to during articulation may result in fracture to the relatively brittle optical fibers within the one or more fiber optic bundles included in an instrument. This may be especially relevant for fiber optic bundles exposed to compressive loads resulting in buckling during an articulation motion. Broken optical fibers may result in less transmission of light along the fiber optic bundle which may result in reduced light efficiency in examples where the fiber optic bundle functions as a light guide. Additionally, these broken optical fibers may result in increased heat dissipation within the fiber optic bundle which may result in thermal dissipation issues within the system. In view of these, and other issues, there are benefits associated with constraining a position of one or more fiber optic bundles within a larger internal channel of the instrument and/or reducing the forces applied to the one or more fiber optic bundles during articulation.

In view of the above, a fiber optic bundle may be used to transmit light through an instrument including an articulable elongated body having an internal channel extending therethrough. The fiber optic bundle may be disposed in and extend along at least a portion of a length of the channel of the elongated body. A sheath may be disposed on and extend along a length of a portion of an associated fiber optic bundle at least in a location corresponding to an articulable portion of the elongated body. For example, the fiber optic bundle may be disposed within and extend through the sheath. The sheath may at least partially shield the fiber optic bundle from axial loads applied to the combined structure of the sheath and fiber optic bundle when the elongated body transitions between an articulated and unarticulated configuration. In some examples, the sheath may be configured to at least partially support compressive axial loads applied to the fiber optic bundle. However, examples in which the sheath is configured to at least partially support tensile axial loads applied to the fiber optic bundle are also contemplated. The sheath may have sufficient lateral flexibility such that the elongated body may still be articulated with the fiber optic bundle and the sheath disposed therein. In some examples, one or more portions of a sheath may be axially fixed relative to the elongated body at one or more locations located distally from and/or proximal to the articulable portion of the elongated body.

As noted above, it may be desirable to provide axial support to offload forces and reduce displacements applied to a fiber optic bundle using a sheath during articulation. In some examples, the sheath may provide this desired functionality by having an axial compressive stiffness that is greater than an axial compressive stiffness of the optical fiber disposed therein. Due to the differences in the axial compressive stiffness of these structures, a majority, and in some examples substantially all, of a compressive axial load applied to the combined structure of the fiber optic bundle and sheath may be supported by the sheath. In some examples, the axial tensile stiffness of the sheath may also be greater than an axial tensile stiffness of the fiber optic bundle. Separately, a lateral stiffness of the sheath may be less than the axial compressive stiffness of the sheath. Specifically, the lateral flexibility of the sheath may be sufficient such that the articulable elongated body, the fiber optic bundle, and sheath are capable of being articulated together while reducing the transmission of compressive axial forces to the fiber optic bundle.

Such a construction may help to reduce the compressive forces, and in some examples the tensile forces, applied to the fiber optic bundle by offloading them to the separate sheath. This may help to reduce (e.g., substantially prevent) buckling and compressive fracture of the fiber optic bundle as the elongated body is articulated between an articulated configuration and an unarticulated configuration. This may provide an enhanced fatigue life for the imaging instrument in some instances. However, other benefits associated with the disclosed constructions may also be provided.

It should be understood that the methods and systems described herein may be applied to any appropriate number of fiber optic bundles disposed within an internal channel formed within an articulable elongated body. This may include configurations in which a single fiber optic bundle is used that is nominally positioned either at, or offset from, a central axis of the internal channel. The disclosed examples may also apply to instruments including a plurality of fiber optic bundles that are offset from the central axis of the internal channel. Accordingly, it should be understood that the current disclosure is not limited to any particular number of fiber optic bundles and that the various constructions and methods of operation described herein may be applied to instruments including any number of fiber optic bundles as the disclosure is not limited in this fashion.

The various examples described herein may be used with any appropriate type of sheath exhibiting the desired compressive axial stiffness and lateral flexibility in a direction perpendicular to the longitudinal axis of the sheath. In some examples, appropriate constructions may include, but are not limited to: solid coil springs where adjacent coil windings are in contact with one another (e.g., a coil pitch and coil diameter are approximately equal) in the undeformed configuration; hollow core cables with fiber optic bundles disposed in the hollow core; overmolded serially arranged rings; serially arranged rings disposed within a flexible outer tube; or any other flexible structure exhibiting the desired combination of axial stiffness and lateral flexibility.

Depending on the specific construction, the sheaths disclosed herein may be made from a variety of materials. Appropriate materials that the sheaths disclosed herein may be made from include, but are not limited to, elastic metals (e.g., stainless steel, nitinol, titanium, etc.), polymers (e.g., silicone, urethane, natural rubber, etc.), combinations of the foregoing, and/or any other appropriate material as the disclosure is not limited in this fashion.

A sheath may have any appropriate length for a desired application. For example, in some examples, a length of a sheath may be equal to or greater than a corresponding length of an articulable portion of an elongated body that a fiber optic bundle passes through. For instance, a length of the sheath may be greater than or equal to 50 mm, 100 mm, 250 mm, and/or any other appropriate length. The length of the sheath may also be less than or equal to 1 m, 500 mm, 250 mm, 100 mm, and/or any other appropriate length. Combinations of foregoing are contemplated including, for example, a length that is between or equal to 50 mm and 1 m, 50 mm and 250 mm, as well as other appropriate combinations. An outer diameter of a sheath may vary based on the specific application. For instance, different instruments may have internal channels with different sizes and the sheath may have an outer maximum transverse dimension (e.g., an outer diameter) that is less than an inner minimum transverse dimension (e.g., an inner diameter) of a channel the sheath and corresponding fiber optic bundle are disposed in. For example, a sheath may have a maximum outer transverse dimension that is greater than or equal to 2 mm, 3 mm, 4 mm, and/or any other appropriate dimension. The sheath may also have a maximum outer transverse dimension that is less than or equal to 5 mm, 4 mm, 3 mm, and/or any other appropriate dimension. Combinations of the foregoing are contemplated including, for example, a sheath with a maximum outer transverse dimension that is between or equal to 2 mm and 5 mm.

In instances in which a solid spring is used as a sheath, the coil windings of the solid spring may have any appropriate size to provide a desired stiffness. For example, a coil spring wire diameter, or other appropriate transverse dimension, may be greater than or equal to 0.1 mm, 0.2 mm, 0.3 mm, 0.4 mm, and/or any other appropriate dimension. The coil spring wire diameter may also be less than or equal to 0.5 mm, 0.4 mm, 0.3 mm, 0.2 mm, and/or any other appropriate dimension. Combinations of the foregoing are contemplated including, for example, a coil spring wire diameter that is between or equal to 0.1 mm and 0.5 mm.

In some examples, it may be desirable to permit a fiber optic bundle to move within an interior of a corresponding sheath to avoid the generation of excessive shear stresses at this interface. Accordingly, in some examples, an imaging instrument may include a gap between an outer maximum transverse dimension (e.g., an outer diameter) of a fiber optic bundle and an inner minimum transverse dimension (e.g., an inner diameter) of a sheath the fiber optic bundle is disposed within. A difference in the maximum outer transverse dimension of the fiber optic bundle and the inner minimum transverse dimension of the sheath may be greater than or equal 0.3 mm, 0.4 mm, 0.5 mm, 0.6 mm, and/or another appropriate dimension. The difference in dimensions may also be less than or equal to 0.8 mm, 0.7 mm, 0.6 mm, 0.5 mm, and/or any other appropriate dimension. Combinations of foregoing are contemplated including, for example, a difference in the maximum outer transverse dimension of fiber optic bundle and the inner minimum transverse dimension of the sheath may be between or equal to 0.3 mm and 0.8 mm.

In some applications, the instruments disclosed herein may be disposed within an internal lumen of a separate elongated delivery system. For example, the disclosed instruments may be disposed within and extend through an internal lumen of a medical delivery system such as an endoscope. Accordingly, the elongated body of an instrument that the fiber optic bundles and sheaths extend through may have an appropriate dimension selected to fit within the internal lumen of the separate elongated delivery system. In some examples, the maximum outer transverse dimension of an elongated body may be greater than or equal to 5 mm, 6 mm, 7 mm, 8 mm, and/or any other appropriate dimension. The maximum outer transverse dimension of the elongated body may also be less than or equal to 10 mm, 9 mm, 8 mm, 7 mm, 6 mm, and/or any other appropriate dimension. Combinations of the foregoing are contemplated including, for example, a maximum outer transverse dimension of the elongated body that is between or equal to 5 mm and 10 mm.

As noted above, the sheaths disclosed herein may reduce a change in path length of a fiber optic bundle within an articulable portion of an elongated body between a fully articulated and unarticulated configuration of the elongated body. In some examples, a change in path length of a fiber optic bundle extending through an articulable portion of the elongated body between an unarticulated configuration and a fully articulated configuration of the elongated body may be less than or equal to 10%, 5%, or any other appropriate percentage of the path length of the fiber optic bundle extending through the articulable portion in the unarticulated configuration.

While specific dimensions for various components of the instruments disclosed herein are described both above and elsewhere in the current disclosure, it should be understood that dimensions both greater than and less than those noted herein may be used as the disclosure is not limited in this fashion.

Depending on the specific construction, different forces may be applied to a fiber optic bundle and sheath during articulation. For example, in some examples, the combination of a fiber optic bundle and corresponding sheath may have axial forces, both compressive and tensile, applied to the combined structure during articulation. These applied axial forces may be greater than or equal to 5 N, 6 N, 7 N, 8 N, and/or any other appropriate force. The applied axial forces may also be less than or equal to 10 N, 9 N, 8 N, 7 N, 6 N, and/or any other appropriate force. Combinations of the foregoing are contemplated including, for example, axial forces applied to the combined structure of a fiber optic bundle and sheath may be between or equal to 5 N and 10 N. However, regardless of the specific forces applied to the combined structure, a majority of the applied axial force, at least in compression, and in some examples in tension as well, may be supported by the sheath. In some examples, the sheath may support greater than or equal to 50%, 60%, 70%, 80%, 90%, and/or any other appropriate percentage of the applied axial force. The sheath may also support less than or equal to 100%, 95%, 90%, 80%, 70%, 60%, and/or any other appropriate percentage of the applied axial force. Combinations of foregoing are contemplated including, for example, a sheath that supports between or equal to 50% and 95%, 50% and 100%, 60% and 100%, 70% and 100%, 80% and 100%, or 90% and 100% of the axial load applied to the combined structure of the fiber optic bundle and the sheath in at least compression, and in some examples, tension as well. Of course, other combinations of the foregoing as well as other percentages and/or different magnitude loads are also contemplated as the disclosure is not limited in this fashion.

It should be understood that there are a number of different constructions for providing an articulable elongated body. For example, in some examples, pin joints disposed between a plurality of rigid links may be used to form an articulable portion of an elongated structure. In other examples, an articulable portion of an elongated body may be made from an inherently elastic material that is capable of deforming to the desired amount of articulation. In yet another example, an articulable portion of an elongated body may include a plurality of slits formed therein to form a plurality of living hinges disposed along a length of an articulable portion of the elongated body. These living hinges may permit the rigid segments disposed between the living hinges to rotate about the living hinges to provide the desired flexibility in the articulable portion. Of course, while specific constructions are described for providing an articulable portion of an elongated body, it should be understood that the current disclosure is not limited to any specific construction of an elongated body as the disclosure is not so limited.

The instruments disclosed herein (including fiber optic bundles and corresponding sheaths) may be used for any desired application in which a fiber optic bundle passes through an elongated body that may undergo articulation. In some specific examples, the disclosed instruments may be articulable imaging instruments including articulable medical imaging instruments. These imaging instruments may either be standalone instruments, or they may be instruments that are passed through an internal lumen of a separate delivery system including an internal lumen that the imaging instrument is passed through. For example, an imaging instrument may be passed through an internal lumen of an endoscope, laparoscope, or catheter depending on the desired application. However, instances in which an elongated body of an imaging instrument is provided in the form of a shaft of an endoscope, laparoscope, catheter, or other instrument are also contemplated. In some instances, the instruments disclosed herein may be used in manually operated systems, robotic assisted surgical systems, teleoperated robotic surgical systems, and/or other desired applications. Of course, it should be understood that the disclosed instruments are not limited to use with only these specific applications.

As used herein, a fiber optic bundle may refer to a plurality of individual optical fibers gathered into a bundle. This may include both individual fiber optic bundles as well as primary fiber optic bundles which may be formed from a plurality of separate fiber optic bundles that are gathered together to form the primary fiber optic bundle.

As used herein, a longitudinal direction may refer to a direction oriented parallel to a long axis of a structure. For example, a longitudinal direction of a channel may correspond to a direction extending along a length of that channel. Correspondingly, a lateral direction may refer to a direction that is oriented perpendicular to the long axis of the structure. For instance, a lateral direction of a channel may correspond to a direction that is perpendicular to a longitudinal axis of the channel.

Turning to the figures, specific non-limiting examples are described in further detail. It should be understood that the various systems, components, features, and methods described relative to these examples may be used either individually and/or in any desired combination as the disclosure is not limited to only the specific examples described herein.

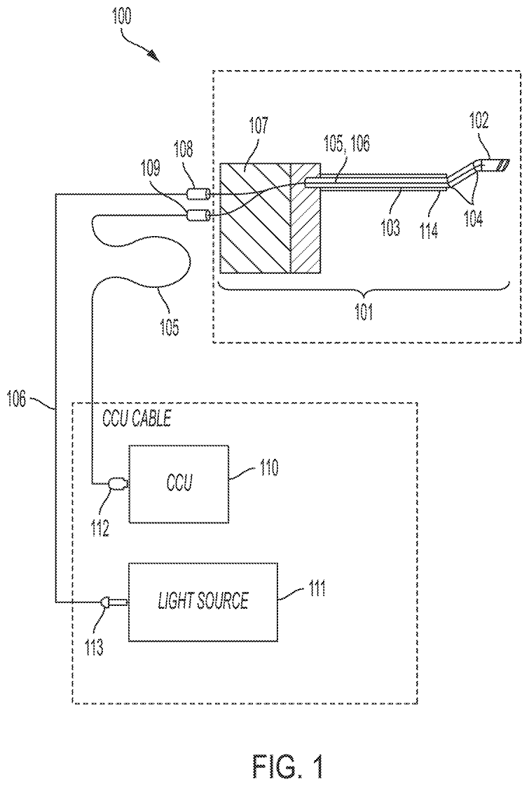

FIG. 1 is a block diagram illustrating a schematic representation of one example of an imaging system 100. The imaging system 100 may be configured for imaging any desired surface. In examples in which the imaging system is a medical imaging system, the surface to be imaged may correspond to tissue of a subject such as a site within a natural cavity and/or surgical site of a subject. The imaging system 100 includes an imaging instrument 101 operatively coupled to an imaging control unit (CCU) 110 and a light source 111.

The imaging instrument 101 comprises an imaging module 102 configured to image a target site. Appropriate types of imaging devices included in an imaging module may include, but are not limited to a camera, a CCD chip, a CMOS chip, photosensitive diodes and/or any other photosensitive detector configured to detect an image or other light-based signal from a target site. The imaging instrument may also include an elongated body 103 with a channel extending along a least a portion of a length of the elongated body. The imaging instrument may also include an instrument housing 107 the elongated body is attached to and extends out from. Electrical cables 105, fiber optic bundles 106, heat exchangers (not depicted), and/or other components may extend through the internal channel of the elongated body and be operatively coupled with one or more components within the imaging module as explained further below. The instrument housing 107 may include a base configured to mount to and dismount from a robotic arm or other structure and/or may include a graspable handle.

In the depicted example, the imaging module 102 may be coupled to a distal end portion of the elongated body 103. Additionally, to provide a desired range of motion of the imaging module, the elongated body may include one or more articulable portions corresponding to one or more articulable joints 104 located along at least a portion of a length of the elongated body. However, other articulable constructions may also be used as previously noted. The one or more articulable portions of the elongated body may permit the imaging module to be articulated in one, or a plurality of directions, to direct the imaging module towards a desired target site for imaging the site. A proximal end portion of the elongated body 103 may be coupled to the instrument housing 107. The instrument housing 107 may house any appropriate actuator (not shown) to manipulate cables, rods, or other transmission components used to articulate the joints, or other type of articulable portion, of the elongated body.

Depending on the example, the elongated body 103 may be sized and shaped to pass through the internal lumen of a delivery system including a proximal opening (e.g., an opening within the housing, handle, or other proximal portion medical instrument) and a distal opening. For example, as shown in the depicted example, the elongated body of the imaging instrument 101 may pass through an internal lumen of a tube 114, though the imaging instrument may be used as a standalone device by itself without a delivery system in some examples. Additionally, the disclosed instruments may be used with other delivery systems including, but not limited to, catheters, laparoscopes, guide tubes, cannulas, and/or other systems as the disclosure is not limited in this manner. Additionally, instances in which the elongated body of the disclosed imaging instruments is provided in the form of an elongated shaft of any one of the above delivery systems are also contemplated. For example, an elongated body of the various imaging instruments disclosed herein may be provided as an elongated shaft of an endoscope in some examples.

In some examples, the cables 105 may be electrical cables extending through the elongated body 103 of the imaging instrument 101 and may be detachably coupled to the imaging control unit (CCU) 110 via one or more selectively detachable connectors 109 and 112 as well as an optional intermediate portion of the electrical cables 105 shown between the connectors. However, other connection arrangements are also contemplated. In either case, the imaging module 102 may be operatively connected with the CCU 110 to allow the transmission of video, image, or other desired signals from the imaging module 102 to the CCU 110. Depending on the example, the CCU may include one or more processors and associated non-transitory computer readable memory, not depicted, including instructions stored thereon that when executed by the one or more processors may perform any of the methods disclosed herein. Correspondingly, the CCU may be operatively coupled to one or more displays, input instruments, and/or any other appropriate component, not depicted.

As noted above, one or more fiber optic bundles 106 may be disposed in and extend through at least a portion of the elongated body 103 of the imaging instrument 101. The one or more fiber optic bundles may correspond to a plurality of optical fibers. The fiber optic bundles may be optically coupled to one or more portions of the optical module as well as an optical connector 113 that selectively couples the one or more fiber optic bundles to a light source 111. In some examples, the imaging system may also include an optional intermediate portion of the one or more fiber optic bundles that extend between a connection 113 with the light source 111 and the connector 108. Of course, other types of connection arrangement are also contemplated as the disclosure is not limited in this fashion. The external light source 111 may include one or more of a Xenon short-arc lamp, a laser, a light emitting diode (LED), and/or any other appropriate type of light source. The one or more fiber optic bundles direct the generated light out a distal end of the imaging module 102 near a corresponding photosensitive detector of the imaging module (not depicted) in some examples. With a plurality of strands of optical fiber, the one or more fiber optic bundles 106 can terminate at more than one point within the imaging module 102 and provide multiple light points. Structures for guiding and protecting the one or more fiber optic bundles during articulation are detailed further below.

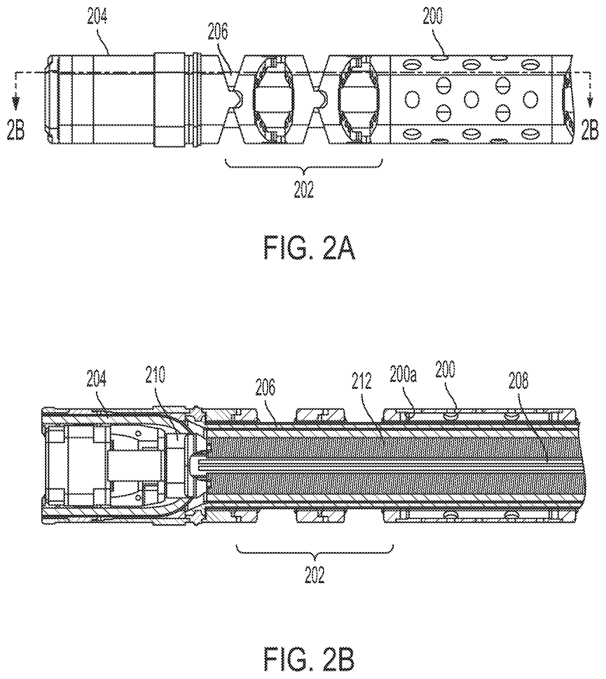

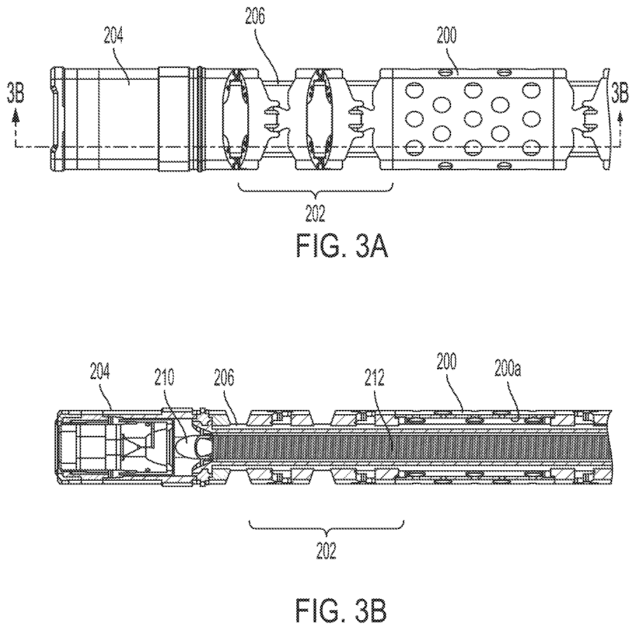

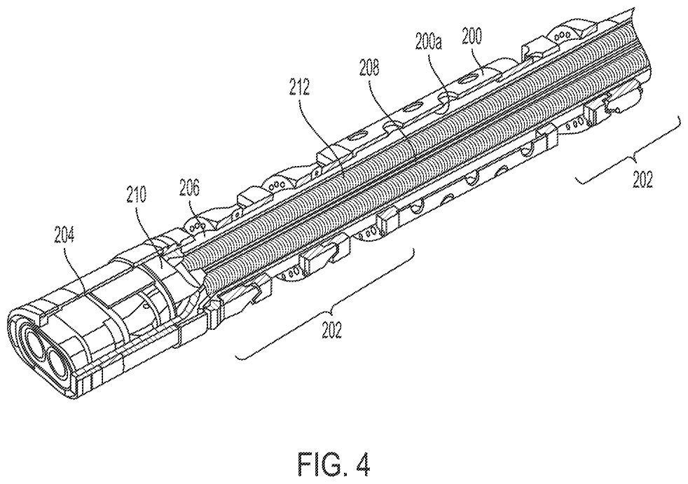

FIGS. 2A-4 depict one example of an imaging instrument that may be articulated to provide a desired position and orientation of a distal portion of the imaging instrument for imaging a desired target. In the depicted example, the imaging instrument includes an elongated body 200. As noted above, the elongated body may extend distally from a support, handle, or other appropriate housing depending on whether the imaging instrument is intended to be a manually operated, autonomously operated, and/or semi-autonomously operated instrument. An imaging module 204 may be connected to a distal end portion of the elongated body. The elongated body may also be sized and shaped to either be used separately or in combination with a separate elongated delivery system, such as an endoscope, including an internal lumen that the imaging instrument may be passed through. Additionally, the elongated body may include one or more articulable portions 202 disposed along a length of the elongated body. In the depicted example, the articulable portion of the elongated body is located on a distal portion of the elongated body. However, the current disclosure is not limited to where an articulable portion is located along a length of an elongated body of an imaging instrument. In the various figures, the articulable portion corresponds to a plurality of rigid links connected to one another by one or more pin joints. However, other appropriate articulable configurations and control schemes may be used as previously described.

To provide access to the imaging module 204 disposed at a distal end portion of the elongated body 200, the elongated body may include an internal channel 200a extending along at least a portion of, and in some instances an entirety of, a length of the elongated body. A number of different components may pass from a proximal opening (not depicted) of the elongated body to the imaging module through the internal channel of the elongated body. As noted above, the proximal opening of the elongated body may be located within a handle, support, or other appropriate housing the elongated body is connected to. The imaging instrument may include one or more fiber optic bundles extending from the proximal opening in the elongated body to the imaging module. The portions of the fiber optic bundles disposed within and extending through the articulable portion of the elongated body are not shown in the current figures, and instead are disposed within one or more corresponding sheaths 212 extending from a position located distal from the one or more articulable portions 202 of the elongated body to a location proximal to the one or more articulable portions of the elongated body.

To provide the desired functionality of reducing lateral offset, buckling, and compressive loads applied to a fiber optic bundle (not depicted) during articulation, the sheath 212 an associated fiber optic bundle is disposed within may exhibit an axial compressive stiffness that is greater than an axial compressive stiffness of the fiber optic bundle. The lateral stiffness of the sheath may also be less than an axial compressive stiffness of the sheath. Accordingly, the sheath may resist overall length changes while still permitting the sheath to deform in a lateral direction to accommodate articulations applied to an instrument. In some examples, an axial tensile stiffness of the sheath may also be greater than an axial tensile stiffness of the associated fiber optic bundle. However, examples in which the axial tensile stiffness of the sheath is equal to or less than an axial tensile stiffness of the associated fiber optic bundle are also contemplated.

In addition to fiber optic bundles extending through the internal channel 200a of an elongated body 200, one or more other components may extend through the elongated body. For example, in some examples, a plurality of electrical cables 208 may extend from the proximal opening of the channel 200a of the elongated body to the imaging module 204. Depending on the specific application, one or more electrical cables may communicate signals from a photosensitive detector included in the imaging module, or any other appropriate sensor, to an associated processor.

In some applications, it may be desirable to position a distal end of the sheaths 212 at a predetermined location relative to the imaging module. For example, as illustrated in the figure, the sheaths may abut against, or be connected to, a coupling 210, or other proximal portion of the imaging module 210. The coupling may function as a stop that the one or more sheaths are disposed against and/or attached to. Thus, in some examples, the one or more sheaths and corresponding one or more fiber optic bundles may be axially fixed relative to the elongated body at the depicted coupling, or other appropriate location along a length of the elongated body located distally from the one or more articulable portions 202. While direct contact between the sheaths and the proximal portion of the imaging module is depicted in the figures, it should be understood that indirect contact through one or more intermediate components is also contemplated as the disclosure is not limited in this fashion. Additionally, the proximal portion of the imaging module may either be an integrated portion of the imaging module, or the proximal portion may correspond to a separately formed component that is connected to and/or disposed on the imaging module. In either case, the one or more fiber optic bundles may pass out of a distal opening of an associated sheath through the proximal portion of the imaging module to a desired location within the imaging module. For example, the one or more fiber optic bundles may extend to a distal end portion of the imaging module to provide illumination light to a target surface the imaging module is oriented towards as part of an imaging process.

In some examples, it may be desirable to provide a barrier between the internal components contained within an elongated body 200 of an imaging instrument and an exterior environment. Accordingly, as shown in the figures, the one or more sheaths 212, electrical cables 208, fiber optic bundles (not shown), and/or any other components extending through an internal channel 200a of the elongated body may be disposed within a flexible barrier 206 that extends along a length of the elongated body. In some examples, the flexible barrier may correspond to a silicone overtube that the other components are disposed within. The flexible barrier may be sealed at a distal end portion either to a section of the elongated body 200, the imaging module 204, and/or any other appropriate component as the disclosure is not limited in this fashion.

While one or more fiber optic bundles and the corresponding sheaths are discussed above, it should be understood that any appropriate number of fiber optic bundles and corresponding sheaths may be included in the internal channel of an elongated body. For example, in some examples, 2, 3, or any other appropriate numbers of fiber optic bundles and corresponding sheaths 212 may be disposed in and extend along a length of an internal channel 200a of an elongated body 200. These fiber optic bundles and sheaths may be laterally offset from a longitudinal axis extending along a length of the channel. This is illustrated in FIG. 2B where two sheaths 212 extend along a length of the internal channel 200a of the elongated body through an articulable portion 202. The sheaths and the fiber optic bundles disposed therein are disposed on opposing sides of the central longitudinal axis of the internal channel. In some examples, this central longitudinal axis may correspond to the neutral bending axes of the channel during articulation of the articulable portion 202. While a specific configuration is shown in the figures, it should be understood that any arrangement of one or more fiber optic bundles and corresponding sheaths disposed in an internal channel of an articulable elongated body may be implemented as the disclosure is not limited in this fashion.

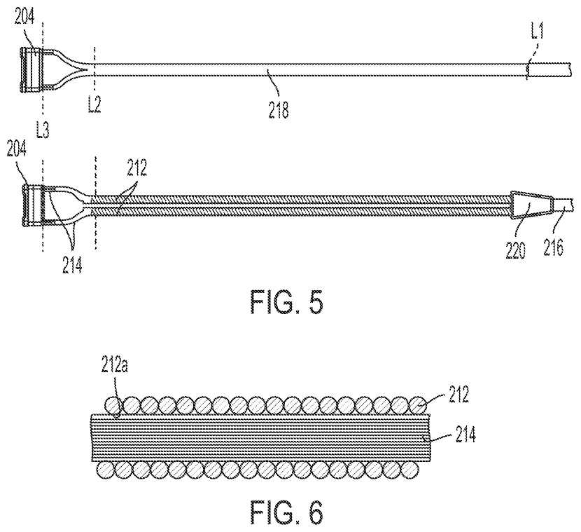

FIG. 5 depicts one example of a plurality of fiber optic bundles 214 that may be included in an imaging instrument. The illustrated structure is shown both with and without an optional elastic jacket 218 disposed on the separate fiber optic bundles and the sheaths 212 that the fiber optic bundles pass through. Depending on the example, the elastic jacket may extend along a portion of the one or more fiber optic bundles and/or along an entire length of the one or more fiber optic bundles as the disclosure is not limited in this fashion. In the depicted example, the fiber optic bundles extend through the corresponding sheaths which may extend at least from a first location L1 that is located proximally to an articulable portion of a corresponding elongated body to a second location L2 that is located distally from the articulable portion of the elongated body as described previously. The one or more fiber optic bundles may continue to extend beyond the sheaths to at least a separate third location L3 within the imaging module 204. Examples in which the one or more fiber optic bundles extend to a distal end of the imaging module are also contemplated.

In examples where multiple fiber optic bundles 214 are used, it may be desirable to combine the separate fiber optic bundles into a primary fiber optic bundle 216 that is easier to route through the various portions of an imaging system. Such an example is shown in FIG. 5 where the primary fiber optic bundle is divided into two separate fiber optic bundles 214 at location L1. In some examples, the primary fiber optic bundle is divided into the separate fiber optic bundles using a divider 220 or other structure configured to support the bifurcated fiber optic bundles. In other words, the fiber optic bundles may be combined to form the primary fiber optic bundle at a location proximal to the articulable portion of the elongated body. In some instances, the divider, or another appropriate coupling, may be used to axially fix a proximal portion of the one or more sheaths 212 relative to a corresponding portion of the associated fiber optic bundles and/or the elongated body (not depicted).

FIG. 6 is a schematic cross-sectional view of a portion of a sheath 212 including a separate internal channel 212a extending therethrough that a fiber optic bundle 214 is disposed within. In the depicted example, the sheath corresponds to a solid coil spring where the individual coil windings are disposed against one another with a zero offset in the unbiased neutral configuration. In other words, a pitch of the coil windings may be equal to a wire diameter or thickness of the spring in the neutral configuration prior to the solid coil spring being articulated. Such a construction may be advantageous as the solid coil spring may efficiently transmit compressive forces along an axial length of the solid coil spring through the contacting coil windings. Additionally, the solid coil spring may be relatively easy to deform in the lateral direction permitting a system including such a sheath to be articulated as previously described. Thus, a solid coil spring may function as a sheath that is stiffer in at least an axial compressive direction as compared to a lateral direction of the sheath which may exhibit a lower stiffness.

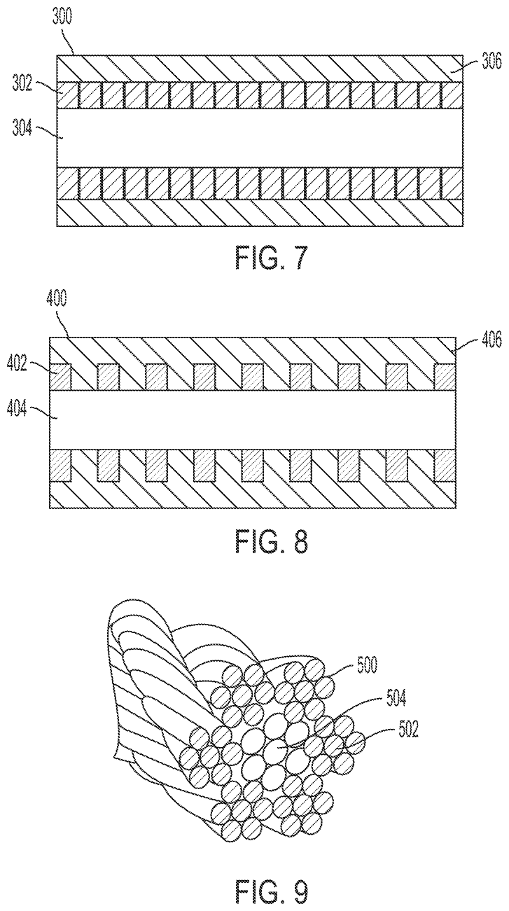

FIG. 7 depicts another example of a sheath. In the depicted example, the sheath 300 includes a plurality of serially arranged rigid rings 302. An internal channel 304 may extend through an interior portion of the serially arranged rigid rings. While the serially arranged rigid rings may be disposed against one another in some examples, the rigid rings might not be rigidly fixed relative to one another. Thus, the rigid rings may be capable of tilting and/or being laterally offset from one another when the sheath is bent as might occur during articulation of an elongated body the sheath is disposed within. In order to maintain the rigid rings in a desired configuration, the stack of serially arranged rigid rings may be disposed within and extend along a length of a flexible tube 306. The flexible tube may be sized and shaped such that it applies a compressive force to the serially arranged rigid rings to maintain them in the desired arrangement during operation. The flexible tube may also exhibit sufficient flexibility to permit the overall assembly to articulate. Due to the rigid rings being disposed against one another in a neutral unbiased configuration, the overall sheath may be capable of efficiently transmitting at least axial compressive forces through the structure with a desired axial stiffness while still permitting the structure to bend to also provide a lower lateral stiffness of the sheath.

FIG. 8 depicts another example of a sheath 400 including a plurality of serially arranged rigid rings with an internal channel 404 extending through the rings and sheath. The serially arranged rigid rings may be maintained in a desired configuration using an overmolded flexible tube 406 that is overmolded onto the rigid rings. Depending on the example, the rigid rings may either be disposed against one another, and/or in instances where a sufficiently thick and/or rigid material is used for the overmolded tube, may be spaced from one another. The depicted sheath may operate in a similar manner to that described above relative to FIG. 7.

FIG. 9 depicts yet another example of a sheath 500. The sheath includes a hollow core cable 502 made from sufficiently rigid materials. For example, the hollow core cable may be a metal wire wound cable including either one or multiple layers of wound strands. The wire cables may exhibit either lang lay or regular lay arrangements of the strands within the cable. Additionally, instances in which a cable may exhibit multiple layers including both lang lay and regular lay strands are also contemplated as such an arrangement may help to improve the axial stiffness of the resulting cable. In either case, a fiber optic bundle 504 may be disposed within and extend through the hollow core of the cable. Given the inherent flexibility and axial stiffness of hollow core cables, such a construction may be used to provide the desired axial stiffness and lateral flexibility desired in the sheaths described herein.

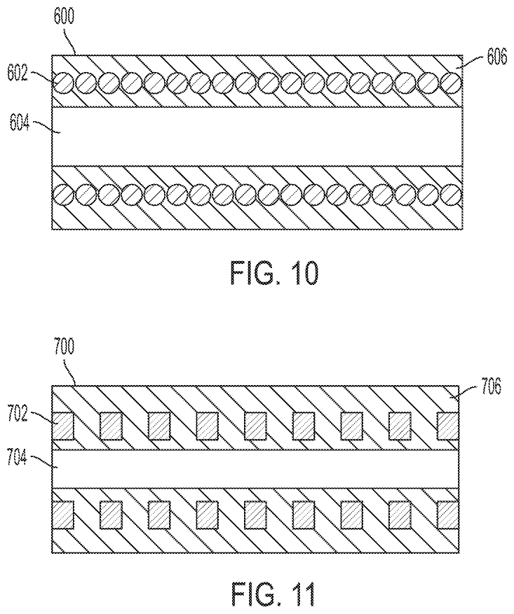

FIG. 10 depicts another example of a sheath 600 including a coil spring 602 with an internal channel 604 extending through the sheath. The coil spring's rigidity may be increased in some examples by using an overmolded flexible tube 606 that is overmolded onto the coil spring. Depending on the example, the coil spring may either be a solid coil spring with adjacent coil windings in contact with one another, or the coil windings may be spaced apart. The depicted sheath may operate in a similar manner to that described above relative to FIG. 7.

FIG. 11 depicts an example of a sheath 700 including a plurality of spaced apart serially arranged rigid rings 702 with an internal channel 704 extending through the rings and sheath. The serially arranged rigid rings may be maintained in a desired configuration using an overmolded flexible tube 706. The overmolded flexible tube is overmolded onto and at least partially, and in some instances fully, encapsulates the rigid rings within the overmolded flexible tube. Accordingly, the overmolded flexible tube may form an interior surface of the internal channel in some examples. The depicted sheath may operate in a similar manner to that described above relative to FIG. 7.

While specific constructions for a sheath are described above, it should be understood that the various examples may be used with any appropriate structure capable of providing the desired functionalities for a sheath described herein. Accordingly, the disclosed examples are not limited to only using sheaths corresponding to the examples described in the figures.

### Example: Articulation of Fiber Optic Bundles Without Sheaths

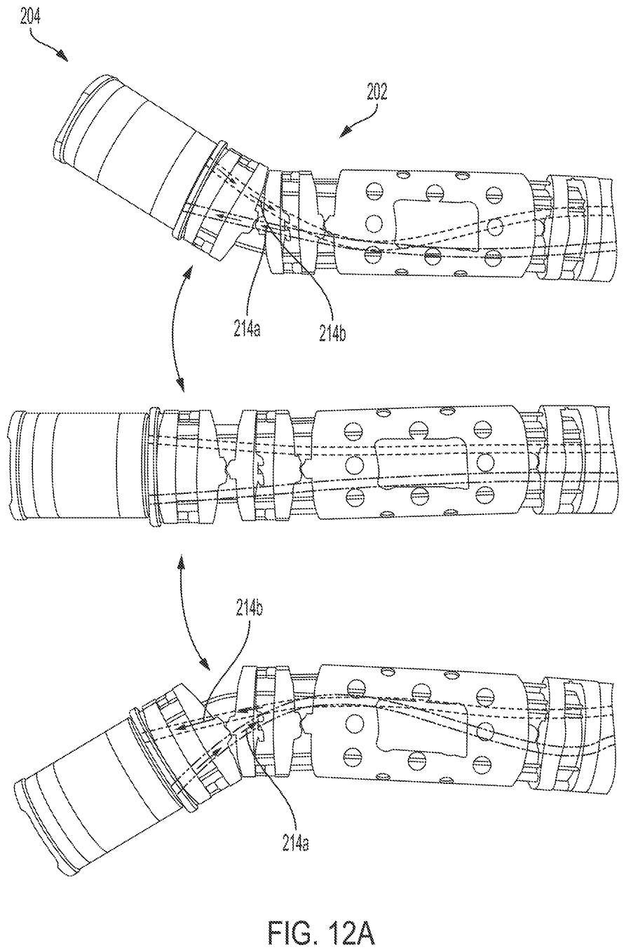

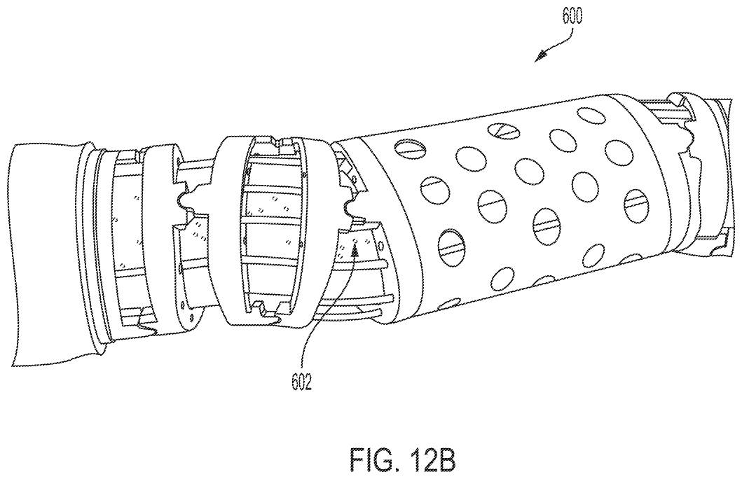

FIG. 12A depicts the paths of two unsupported fiber optic bundles 214a and 214b extending through an articulable portion 202 of an articulable elongated body in various articulated and unarticulated configurations. The paths of the fiber optic bundles within the imaging instrument were determined experimentally using backlighting and imaging of the overall assembly. As can be seen in the figure, in an initial unarticulated (e.g., straight) configuration the fiber optic bundles 214a and 214b, which only included a typical outer coating or jacket, were disposed on either side of a central axis of the instrument and extended along an approximately straight path to a distal end portion of the instrument. However, during articulation in an upwards direction, a distal portion of the fiber optic bundle 214b was compressed in a proximal direction causing the fiber optic bundle 214b to buckle and move laterally to accommodate the excess length of the fiber optic bundle in the articulated portion of the elongated body. In contrast, fiber optic bundle 214a was placed into tension and did not undergo as large a path change within the articulated portion of the instrument. Similar, but opposite, behavior was observed for the fiber optic bundles when the articulable portion was articulated in the opposite downwards direction.

As noted previously, the observed lateral offset and buckling of the fiber optic bundles during articulation may lead to accelerated fatigue and failure of the individual optical fibers contained within the fiber optic bundles. FIG. 12B illustrates bright points 602 located along the length of an articulable portion 600 of an elongated body. The bright points correspond to light leakage from broken sections of the optical fibers along a length of the fiber optic bundles. As the number of broken optical fibers increases, a light transmission efficiency of the fiber optic bundles may continue to decrease until the instrument is no longer operational.

While the present teachings have been described in conjunction with various examples, it is not intended that the present teachings be limited to such examples. On the contrary, the present teachings encompass various alternatives, modifications, and equivalents, as will be appreciated by those of skill in the art. Accordingly, the foregoing description and drawings are by way of example only.

1. An imaging instrument comprising:
an elongated body including a channel extending through the elongated body, wherein the elongated body includes an articulable portion extending along at least a portion of a length of the elongated body;
a fiber optic bundle configured to be operatively coupled to a light source, wherein the fiber optic bundle is disposed in and extends through the channel of the elongated body; and
a sheath disposed in the channel, wherein at least a portion of the fiber optic bundle is disposed in the sheath, and wherein an axial compressive stiffness of the sheath is greater than an axial compressive stiffness of the fiber optic bundle.

2. The imaging instrument of claim 1, wherein a lateral stiffness of the sheath is less than the axial compressive stiffness of the sheath.

3. The imaging instrument of claim 1, wherein the sheath is axially fixed relative to both the elongated body and the fiber optic bundle at a distal location positioned distal from the articulable portion of the elongated body.

4. The imaging instrument of claim 3, wherein the sheath extends from the distal location to a proximal location positioned proximal to the articulable portion of the elongated body.

5. (canceled)

6. The imaging instrument of claim 1, wherein the fiber optic bundle and the sheath are laterally offset from a central longitudinal axis of the channel in at least one configuration of the articulable portion.

7. The imaging instrument of claim 1, wherein the fiber optic bundle is a first fiber optic bundle and the sheath is a first sheath, and wherein the imaging instrument further comprises:
a second fiber optic bundle configured to be operatively coupled to the light source, wherein the second fiber optic bundle is disposed in and extends through the channel of the elongated body, and
a second sheath disposed in the channel, wherein at least a portion of second fiber optic bundle is disposed in the second sheath,
wherein the fiber optic bundle and the second fiber optic bundle form a primary fiber optic bundle at a location proximal to the articulable portion of the elongated body.

8. (canceled)

9. The imaging instrument of claim 1, wherein the sheath comprises a solid coil spring.

10. The imaging instrument of claim 1, wherein the sheath comprises a plurality of joined serially arranged rings.

11. The imaging instrument of claim 1, wherein the sheath comprises a hollow core cable.

12. The imaging instrument of claim 1, further comprising a photosensitive detector disposed on a distal portion of the elongated body located distally from the articulable portion of the elongated body.

13. The imaging instrument of claim 12, wherein the photosensitive detector is oriented in a distal direction, and wherein the fiber optic bundle extends up to a distally oriented surface of the distal portion of the elongated body.

14. The imaging instrument of claim 1, wherein the elongated body is configured to pass through an internal lumen of an endoscope.

15-16. (canceled)

17. A method of illuminating a surface, the method comprising:
articulating an articulable portion of an elongated body including a channel extending through the elongated body;
illuminating the surface with light emitted from a fiber optic bundle disposed in and extending through the channel of the elongated body; and
limiting axial movement of at least a portion of the fiber optic bundle disposed in the articulable portion of the elongated body with a sheath disposed in the channel.

18. The method of claim 17, further comprising at least partially shielding the fiber optic bundle from axial stresses with the sheath.

19. The method of claim 17, further comprising imaging the surface.

20. The method of claim 19, wherein imaging the surface includes imaging the surface with a photosensitive detector disposed on a distal portion of the elongated body located distally from the articulable portion of the elongated body.

21. (canceled)

22. The method of claim 17, wherein an axial compressive stiffness of the sheath is greater than an axial compressive stiffness of the fiber optic bundle.

23. The method of claim 17, wherein a lateral stiffness of the sheath is less than an axial compressive stiffness of the sheath.

24. The method of claim 17, wherein the fiber optic bundle and the sheath are laterally offset from a central longitudinal axis of the channel in at least one configuration of the articulable portion.

25-28. (canceled)

29. The method of claim 17, further comprising passing the elongated body through an internal lumen of an endoscope.

30-43. (canceled)
